(19) United States
(12) Patent Application Publication
(10) Pub. No.: US 2025/0328635 A1
(43) Pub. Date: Oct. 23, 2025

(54) DATA PROCESSING METHOD, APPARATUS AND DEVICE

(71) Applicant: Alipay (Hangzhou) Information Technology Co., Ltd., Hangzhou (CN)

(72) Inventor: Huijia ZHU, Hangzhou (CN)

(21) Appl. No.: 18/868,580

(22) PCT Filed: May 10, 2023
(86) PCT No.: PCT/CN2023/093275

§ 371 Date: Nov. 22, 2024

(30) Foreign Application Priority Data
May 26, 2022 (CN) 202210582554.1

(51) Int. Cl. G06F 21/55

(52) U.S. Cl. CPC G06F 21/552; G06F 2221/034

(57) ABSTRACT

Embodiments of this specification provide a data processing method, apparatus, and device. The method includes: obtaining a to-be-identified target object; if the target object includes a word matching a first argot, obtaining a target corpus corresponding to the target object from a corpus included in a pre-constructed corpus database, where the pre-constructed corpus database includes a first corpus, the first corpus is a risk corpus constructed based on a second argot and a target risk corpus, and the target risk corpus includes a risk word that has a preset association relationship with the second argot; and determining, based on a similarity between the target object and the target corpus and a risk label of the target corpus, whether the target object has a risk.

### TECHNICAL FIELD

This document relates to the field of data processing technologies, and in particular, to a data processing method, apparatus, and device.

### BACKGROUND

With rapid development of computer technologies, a scale of a network service market becomes increasingly larger. However, with continuous development of network services, a new platform is also provided for a malicious third party. The malicious third party can bypass a risk prevention and control system by using an argot with a hidden meaning, to do an illegal activity. Because the argot with a hidden meaning usually has a relatively high similarity to a risk-free word, the argot cannot be accurately identified only through word matching.

Whether there is a risk in a current scenario can be manually determined based on a context of the argot. However, there is a relatively large data amount of a to-be-identified object, and data processing efficiency and data processing accuracy are low in a manual determining manner. Consequently, risk prevention and control efficiency and accuracy are low. In view of this, a solution that can improve risk prevention and control efficiency and accuracy for an argot in a risk control scenario is needed.

### SUMMARY

Embodiments of this specification aim to provide a solution capable of improving risk prevention and control efficiency and accuracy for an argot in risk control scenario.

To implement the above-mentioned technical solutions, the embodiments of this specification are implemented as follows: According to a first aspect, an embodiment of this specification provides a data processing method, including: obtaining a to-be-identified target object; upon determining that the target object includes a word matching a first argot, obtaining a target corpus corresponding to the target object from a corpus included in a pre-constructed corpus database, where the pre-constructed corpus database includes a first corpus, the first corpus is a risk corpus constructed based on a second argot and a target risk corpus, and the target risk corpus includes a risk word that has a preset association relationship with the second argot; and determining, based on a similarity between the target object and the target corpus and a risk label of the target corpus, whether the target object has a risk.

According to a second aspect, an embodiment of this specification provides a data processing apparatus, including: an object obtaining module, configured to obtain a to-be-identified target object; a corpus obtaining module, configured to: upon determining that the target object includes a word matching a first argot, obtain a target corpus corresponding to the target object from a corpus included in a pre-constructed corpus database, where the pre-constructed corpus database includes a first corpus, the first corpus is a risk corpus constructed based on a second argot and a target risk corpus, and the target risk corpus includes a risk word that has a preset association relationship with the second argot; and a risk determining module, configured to determine, based on a similarity between the target object and the target corpus and a risk label of the target corpus, whether the target object has a risk.

According to a third aspect, an embodiment of this specification provides a data processing device. The data processing device includes a processor; and a storage, configured to store computer-executable instructions. When the executable instructions are executed, the processor is enabled to: obtain a to-be-identified target object; upon determining that the target object includes a word matching a first argot, obtain a target corpus corresponding to the target object from a corpus included in a pre-constructed corpus database, where the pre-constructed corpus database includes a first corpus, the first corpus is a risk corpus constructed based on a second argot and a target risk corpus, and the target risk corpus includes a risk word that has a preset association relationship with the second argot; and determine, based on a similarity between the target object and the target corpus and a risk label of the target corpus, whether the target object has a risk.

According to a fourth aspect, an embodiment of this specification provides a storage medium. The storage medium is configured to store computer-executable instructions, and when the executable instructions are executed, the following procedure is implemented: obtaining a to-be-identified target object; upon determining that the target object includes a word matching a first argot, obtaining a target corpus corresponding to the target object from a corpus included in a pre-constructed corpus database, where the pre-constructed corpus database includes a first corpus, the first corpus is a risk corpus constructed based on a second argot and a target risk corpus, and the target risk corpus includes a risk word that has a preset association relationship with the second argot; and determining, based on a similarity between the target object and the target corpus and a risk label of the target corpus, whether the target object has a risk.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show merely some embodiments recorded in this specification, and a person of ordinary skill in the art can still derive other drawings from these accompanying drawings without creative efforts.

FIG. 1A is a flowchart illustrating an embodiment of a data processing method, according to this specification;

FIG. 1B is a schematic diagram illustrating a processing process of a data processing method, according to this specification;

FIG. 2 is a schematic diagram illustrating a processing process of another data processing method, according to this specification;

FIG. 3 is a schematic diagram illustrating a preset risk word knowledge map, according to this specification;

FIG. 4 is a schematic diagram illustrating a processing process of a data processing method, according to this specification;

FIG. 5 is a schematic structural diagram illustrating an embodiment of a data processing apparatus, according to this specification; and

FIG. 6 is a schematic structural diagram illustrating a data processing device, according to this specification.

### DESCRIPTION OF EMBODIMENTS

Embodiments of this specification provide a data processing method, apparatus, and device.

To make a person skilled in the art better understand the technical solutions in this specification, the following clearly and comprehensively describes the technical solutions in the embodiments of this specification with reference to the accompanying drawings in the embodiments of this specification. Clearly, the described embodiments are merely some but not all of the embodiments of this specification. All other embodiments obtained by a person of ordinary skill in the art based on the embodiment of this specification without creative efforts shall fall within the protection scope of this specification.

### Embodiment 1

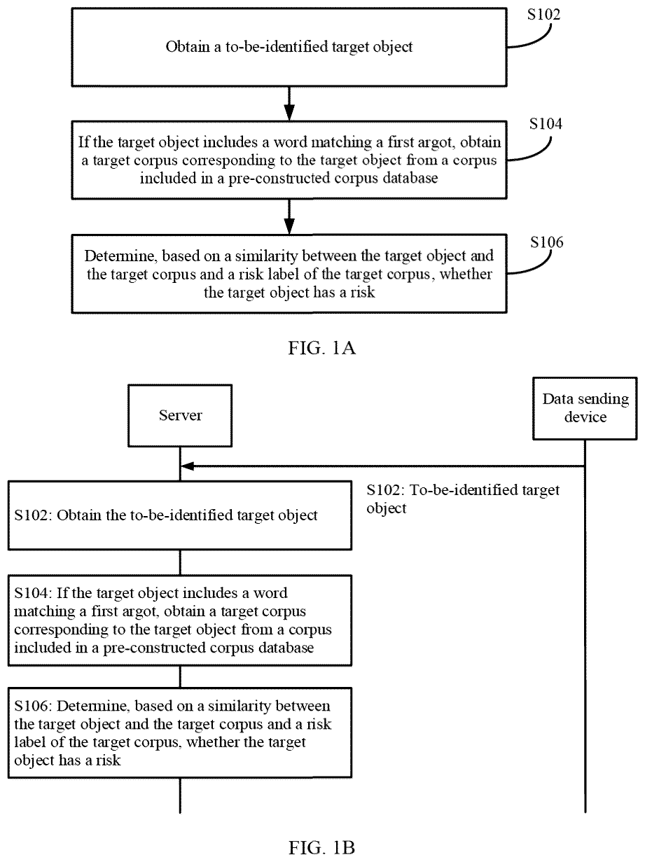

As shown in FIG. 1A and FIG. 1B, this embodiment of this specification provides a data processing method. The method can be performed by a server. The server can be an independent server, or can be a server cluster including a plurality of servers. The method can specifically include the following steps S102 to S106.
S102: Obtain a to-be-identified target object.

The to-be-identified target object can be any text object, picture object, video object, voice object, etc.

During implementation, with rapid development of computer technologies, a scale of a network service market becomes increasingly larger. However, with continuous development of network services, a new platform is also provided for a malicious third party. The malicious third party can bypass a risk prevention and control system by using an argot with a hidden meaning, to do an illegal activity. Because the argot with a hidden meaning usually has a relatively high similarity to a risk-free word, the argot cannot be accurately identified only through word matching.

Whether there is a risk in a current scenario can be manually determined based on a context of the argot. However, there is a relatively large data amount of a to-be-identified object, and data processing efficiency and data processing accuracy are low in a manual determining manner. Consequently, risk prevention and control efficiency and accuracy are low. In view of this, a solution that can improve risk prevention and control efficiency and accuracy for an argot in a risk control scenario is needed. In view of this, this embodiment of this specification provides a technical solution that can resolve the above-mentioned problem. For details, references can be made to the following content.

The to-be-identified target object in the risk control scenario can be obtained. For example, the server can use, as the to-be-identified target object, obtained interaction content (for example, text interaction content or voice interaction content) between users in a resource transfer service scenario. Specifically, a user a can trigger a start of an interaction page with a user b by using a resource transfer application installed in a terminal device, and interact with the user b on the interaction page. The terminal device can send interaction content between the user a and the user b to the server as the to-be-identified target object.

Before sending the interaction content to the server, the terminal device can perform, by using a preset masking model (the masking model can be obtained by performing model training in advance by using the server and obtained training sample), masking processing on user privacy data that may be included in the interaction content, and send the interaction content after the masking processing to the server as the target object; or after receiving an authorization instruction of the user (that is, the terminal device can be authorized to send the interaction content to the server for risk identification processing), the terminal device can send the interaction content to the server for processing.

In addition, that the target object is the interaction content between the users in the resource transfer service scenario. In an actual application scenario, there can be a plurality of different target objects. For example, the target object can be an object (for example, text content, picture content, or video content delivered by the third party) delivered by the third party on a preset display page in a page browsing scenario. Different target objects can be determined based on different actual application scenarios. The target object is not specifically limited in this embodiment of this specification.
S104: If the target object includes a word matching a first argot, obtain a target corpus corresponding to the target object from a corpus included in a pre-constructed corpus database.

The pre-constructed corpus database can include a first corpus. The first corpus can be a risk corpus constructed based on a second argot and a target risk corpus. The target risk corpus includes a risk word that has a preset association relationship with the second argot. The first argot and the second argot can include a word with a hidden meaning in addition to a well-known common meaning of the word. The first argot and the second argot can be determined by the server through big data analysis. For example, for “four big things”, a well-known common meaning of the word is four household appliances, and a hidden meaning of the word is four types of privacy data (for example, an identity card, a bank account, a password, and a mobile phone number) required for stealing user property by the malicious third party. The first argot and the second argot can be the same or can be different. The risk word that has the preset association relationship with the second argot can be a word, etc. whose similarity to the second argot is greater than a preset similarity threshold. The target risk corpus can be a corpus including the risk word. For example, the second argot can be “four big things”, and the risk word that has the preset association relationship with the second argot can be “three big things”, “four essentials”, etc. The target risk corpus including the risk word can be “four essentials for beginners”, etc. The first corpus can be constructed based on the second argot “four big things” and the target risk corpus “four essentials for beginners”. For example, the constructed first corpus can be “four big things for beginners”.

During implementation, there can be a plurality of first argots. The server can obtain one or more corresponding first argots based on a scenario identifier of an application scenario of the target object, and then perform matching processing on the obtained first argot and the target object, to determine whether the target object includes a word matching the obtained first argot. For example, the scenario identifier of the application scenario corresponding to the target object indicates the resource transfer scenario. The server can obtain the first argot corresponding to the resource transfer scenario based on the scenario identifier, and determine, based on a regular expression, whether the target object includes a word matching the first argot.

In addition, there can be a plurality of types of target objects. For example, the target object can be one or more of a text object, a picture object, a video object, or a voice object. Before the server performs matching processing, if the target object is a non-text object, the server can perform text extraction processing on the target object, to obtain text data corresponding to the target object, and then the server performs matching processing based on the text data of the target object and the first argot, to determine whether the target object includes a word matching the first argot. For example, the target object can be a voice object, and the server can perform text conversion processing on the voice object based on a preset voice conversion algorithm, to obtain the text data of the target object; or the target object can be a video object, and the server can perform text conversion processing on voice data in the video object, can further perform text extraction processing on picture data included in the video object, and can determine the text data of the target object based on a processing result.

If it is determined that the target object includes a word matching the first argot, the server can obtain the target corpus corresponding to the target object from the pre-constructed corpus database. For example, the server can successively obtain similarities between the target object and all corpora in the corpus database based on a preset similarity determining model, and then, determine that a corpus whose similarity is greater than a first preset similarity threshold is the target corpus corresponding to the target object. Alternatively, the server can determine that a corpus including the first argot in the corpora is the target corpus corresponding to the target object.

There can be a plurality of methods for determining the target corpus of the target object. The method can vary with the actual application scenario. This is not specifically limited in this embodiment of this specification.
S106: Determine, based on a similarity between the target object and the target corpus and a risk label of the target corpus, whether the target object has a risk.

During implementation, the server can determine a degree of association between the target object and the risk label based on a similarity between the target object and each target corpus, and then determine, based on the degree of association between the target object and the risk label, whether the target object has a risk.

For example, it is assumed that the target corpus corresponding to the target object includes a corpus 1, a corpus 2, and a corpus 3. A risk label of the corpus 1 and the corpus 2 is a label 1, and a risk label of the corpus 3 is a label 2. It is assumed that a similarity between the target object and the corpus 1 is 70%, a similarity between the target object and the corpus 2 is 60%, and a similarity between the target object and the corpus 3 is 62%. The server can determine that a degree of association between the target object and the label 1 is (70%+60%)/2=0.65, and a degree of association between the target object and the label 2 is 0.62. The server can determine that a risk label of the target object is the label 1. If a risk level of the label 1 in an application scenario corresponding to the target object is greater than a preset risk level, the server can determine that the target object has a risk.

A method for determining whether the target object has a risk is an optional and implementable determining method. In an actual application scenario, there can be a plurality of different determining methods. The determining method can vary with the actual application scenario. This is not specifically limited in this embodiment of this specification.

This embodiment of this specification provides the data processing method. The to-be-identified target object is obtained. If the target object includes a word matching the first argot, the target corpus corresponding to the target object is obtained from the corpus included in the pre-constructed corpus database. The pre-constructed corpus database includes the first corpus, the first corpus is the risk corpus constructed based on the second argot and the target risk corpus, and the target risk corpus includes the risk word that has the preset association relationship with the second argot. Whether the target object has a risk is determined based on the similarity between the target object and the target corpus and the risk label of the target corpus. In this way, whether the target object has a risk can be determined based on the target corpus that corresponds to the target object and that is obtained from the pre-constructed corpus database, to avoid low data processing efficiency caused by a manual determining manner. In addition, the first corpus in the pre-constructed corpus database is a risk corpus constructed based on the second argot and the target risk corpus, and the target risk corpus includes the risk word that has the preset association relationship with the second argot. Therefore, whether the target object has a risk can be accurately determined based on the determined similarity between the target corpus and the target object and the risk label of the target corpus. In other words, risk prevention and control efficiency and accuracy for the argot in the risk control scenario can be improved.

### Embodiment 2

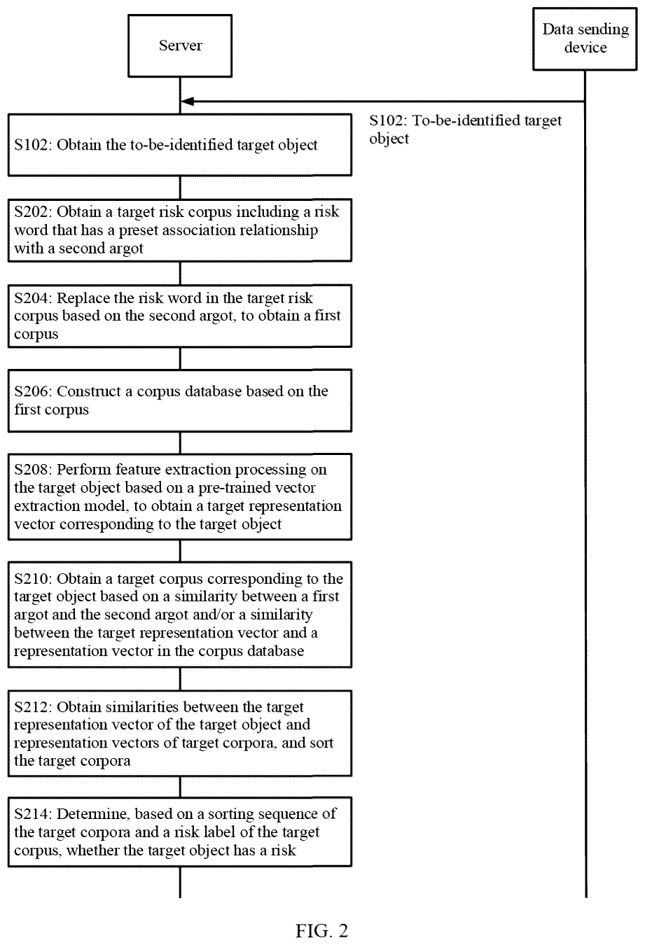

As shown in FIG. 2, this embodiment of this specification provides a data processing method. The method can be performed by a server. The server can be an independent server, or can be a server cluster including a plurality of servers. The method can specifically include the following steps.
S102: Obtain a to-be-identified target object.
S202: Obtain a target risk corpus including a risk word that has a preset association relationship with a second argot.

During implementation, in actual applications, S202 can be processed in a plurality of manners. The following further provides an optional implementation. For details, references can be made to step 1 to step 3.
Step 1: Obtain a first risk word that has the preset association relationship with the second argot.

During implementation, the server can determine a degree of association between the second argot and each risk word in a risk word list based on a pre-constructed degree of association identification model, and then determine, based on the degree of association between the second argot and each risk word, the first risk word that has the preset association relationship with the second argot.

The degree of association identification model can be obtained by training, based on a historical argot and a historical word, a model constructed based on a deep learning algorithm.

In addition, there can be a plurality of methods for determining the first risk word. For example, the first risk word that has the preset association relationship with the second argot can be determined manually, and different determining methods can be selected based on different actual application scenarios. This is not specifically limited in this embodiment of this specification.
Step 2: Obtain a second risk word that is in a preset risk word knowledge map and that has the preset association relationship with the first risk word.

The preset risk word knowledge map can be used to store a risk entity (for example, a user or a service), the risk word, etc. The risk word knowledge map can be stored in a graph database. The preset risk word knowledge map can be a knowledge map constructed by the server based on a historical risk word and a risk corpus including the historical risk word.

During implementation, because an argot updating speed is relatively fast, a model may be incapable of accurately identifying a hidden meaning included in the argot. Therefore, the risk word that has the preset association relationship with the second argot can be determined manually. However, because there may be a relatively large quantity of risk words, to improve data processing efficiency, the first risk word that has the preset association relationship with the second argot can be determined manually. In other words, the server can receive the first risk word that has the preset association relationship with the second argot and that is determined manually, and then the server obtains, based on the preset risk word knowledge map, the second risk word that has the preset association relationship with the first risk word.

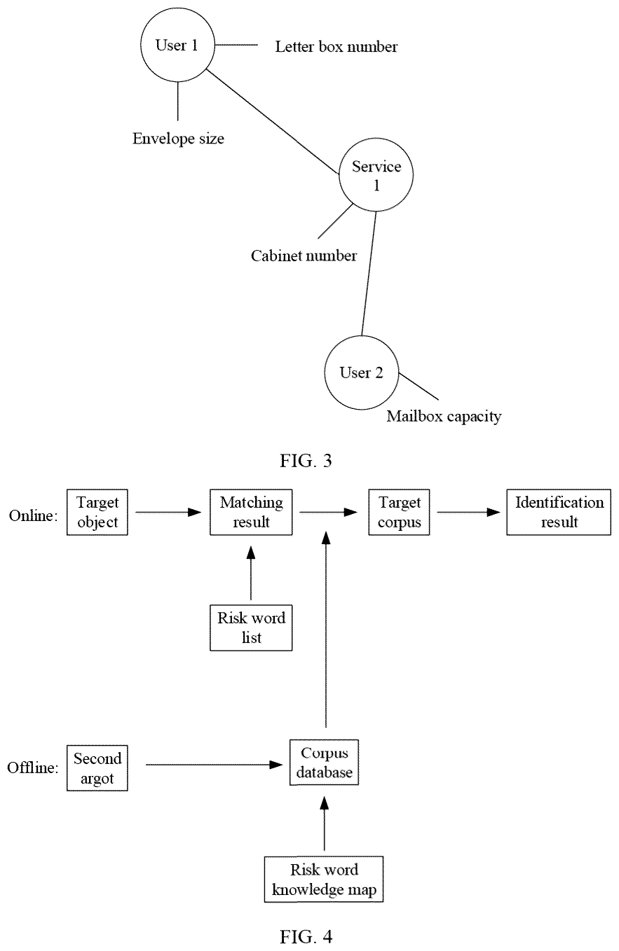

For example, it is assumed that the second argot is “envelope size” (a well-known common meaning of the word is a size of an envelope, for example, a large size, a medium size, or a small size, a hidden meaning of the word is an account number of the user, for example, a mobile phone number, an instant messaging account number, or a resource transfer account number), and the first risk word that has the preset association relationship with the second argot can be “letter number”. The server can query the preset risk word knowledge map for a second risk word that has the preset association relationship with “letter number”. For example, a corresponding second risk word can be obtained based on an association relationship of a risk word in the preset risk word knowledge map. Specifically, in a risk word knowledge map shown in FIG. 3, second risk words such as “letter box number”, “cabinet number”, and “mailbox capacity” can be obtained based on the risk word knowledge map.

The above-mentioned method for obtaining the second risk word is an optional and implementable method. In an actual application scenario, there can be a plurality of different obtaining methods. The obtaining method can vary with the actual application scenario. This is not specifically limited in this embodiment of this specification.
Step 3: Determine, as the target risk corpus, a risk corpus including the first risk word and a risk corpus including the second risk word.

During implementation, there can be a plurality of risk corpora including the first risk word (or the second risk word), and a risk corpus including a risk word (namely, the first risk word or the second risk word) can be a risk corpus obtained based on a preset risk identification model.
S204: Replace the risk word in the target risk corpus based on the second argot, to obtain a first corpus.

During implementation, for example, the target risk corpus can be “pick up all valuable items in a cabinet whose cabinet number is xx”. The server can replace “cabinet number” (namely, a risk word that has the preset association relationship with the second argot) in the target risk corpus with the second argot “envelope size”. The first corpus obtained through replacement can be “pick up all valuable items in an envelope whose envelope size is xx”.

Because the argot updating speed is relatively fast, a data amount of a risk corpus that includes the argot and that can be obtained is relatively small. A relatively large quantity of risk corpora (namely, the first corpus) including the argot can be constructed in the above-mentioned manner, and the target risk corpus used to construct the first risk corpus is a corpus marked with “risk”. Therefore, identification accuracy of subsequently performing argot identification based on the constructed first corpus can be improved based on the constructed first corpus.
S206: Construct a corpus database based on the first corpus.

The pre-constructed corpus database further includes a second corpus, and the second corpus can be a risk-free corpus including the second argot.

During implementation, the server can obtain the risk-free corpus including the second argot, and determine the obtained risk-free corpus as the second corpus. For example, the second argot can be “envelope size”, and the obtained second corpus can be “buy several envelopes whose envelope sizes are a small size”, etc.

The server can determine, as the second corpus, the risk-free corpus including the second argot, and construct the corpus database based on the first corpus and the second corpus. In this way, the constructed corpus database is a corpus database including a black sample (namely, the first corpus) and a white sample (namely, the second corpus). Argot identification accuracy can be improved based on the corpus database.

In actual applications, there may be various processing manners of constructing the corpus database based on the first corpus and the second corpus. The following further provides an optional implementation. For details, references can be made to step 1 and step 2.
Step 1: Perform feature extraction processing on the first corpus and the second corpus based on a pre-trained vector extraction model, to obtain a first representation vector corresponding to the first corpus and a second representation vector corresponding to the second corpus.

The vector extraction model can be a model that can perform feature extraction on a corpus. For example, the vector extraction model can be a bidirectional encoder representations from transformer (BERT) model, or can be a vector extraction submodel in a classification model in a risk identification scenario. There can be a plurality of constitution manners of the vector extraction model. Different vector extraction models can be selected based on different actual application scenarios. This is not specifically limited in this embodiment of this specification.
Step 2: Construct the corpus database based on the second argot, the first representation vector, a risk label of the first corpus, the second representation vector, and a risk label of the second corpus.
S208: Perform feature extraction processing on the target object based on the pre-trained vector extraction model, to obtain a target representation vector corresponding to the target object.

The vector extraction model can be the vector extraction model in S206. To be specific, a model that performs feature extraction processing on the target object can be the same as a model that performs feature extraction processing on the first corpus (or the second corpus).
S210: Obtain a target corpus corresponding to the target object based on a similarity between a first argot and the second argot and/or a similarity between the target representation vector and a representation vector in the corpus database.

During implementation, there can be a plurality of target corpora. As shown in FIG. 4, the server can construct the corpus database based on the second argot and a risk knowledge map in an offline phase, and obtain the to-be-identified target object in an online phase. The server can perform matching processing on the to-be-identified target object based on the risk word list, to obtain a matching result for the target object. If the server determines, based on the matching result, that the target object includes a word matching the first argot, the server can perform feature extraction processing on the target object based on the pre-trained vector extraction model, to obtain the target representation vector corresponding to the target object, and then obtain the similarity between the first argot and the second argot and the similarity between the target representation vector and the representation vector in the corpus database, to obtain the target corpus corresponding to the target object.

After determining the first argot, the server can add the first argot to the risk word list. In other words, the server can update the risk word list in real time. In this way, the server can perform risk identification processing on the target object based on a preset time level (for example, an hour level).
S212: Obtain similarities between the target representation vector of the target object and representation vectors of the target corpora, and sort the target corpora.

During implementation, after obtaining the target corpus, the server can sort the target corpora based on the similarities between the target representation vector of the target object and the representation vectors of the target corpora. For example, the server can sort the target corpora in descending order of similarities between the target representation vector of the target object and the representation vectors of the target corpora.
S214: Determine, based on a sorting sequence of the target corpora and a risk label of the target corpus, whether the target object has a risk.

During implementation, a risk value of the target object can be determined based on the sorting sequence of the target corpora and the risk label of the target corpus.

In actual applications, the risk value of the target object can be determined in a plurality of manners. The following further provides an optional implementation. For details, references can be made to step 1 to step 4.
Step 1: Determine a risk weight of each target corpus based on the sorting sequence of the target corpora.
Step 2: Determine a risk value of the target corpus based on the risk label of the target corpus.

During implementation, there are different risk identification requirements in different application scenarios. For example, a risk value of a risk label 1 can be 0.2 in a resource transfer scenario, and a risk value of the risk label can be 0.5 in an instant messaging scenario. Therefore, the server can obtain the risk value corresponding to the risk label based on an application scenario of the target corpus, and determine the risk value of the target corpus.

In addition, the server can set a risk value corresponding to the risk label of the first corpus to a positive number, and set a risk value corresponding to the risk label of the second corpus to a negative number, to distinguish between the first corpus and the second corpus (that is, to distinguish between the risk corpus and the risk-free corpus).
Step 3: Determine the risk value of the target object based on the risk weight and the risk value of each target corpus.
Step 4: Determine, based on the risk value of the target object, whether the target object has a risk.

During implementation, the server can determine the risk weight of the target corpus based on a ranking of each target corpus (for example, if there are 10 target corpora, a risk weight of the 1^{st} target corpus can be (10−1)/10=0.9). The server can use a product of the risk weight of the target corpus and the risk value as the target risk value of the target corpus. Finally, the server can determine an average value (or a largest value, etc.) of target risk values of the target corpora as the risk value of the target object.

For example, the target corpora can include a corpus a, a corpus b, and a corpus c. The similarity between the target representation vector of the target object and the representation vector of the target corpus and the risk value that is of the target corpus and that is determined based on the risk label of the target corpus can be shown in Table 1.

TABLE 1

| | | | | | Target |
|---|---|---|---|---|---|
| | | | Risk | | risk |
| | Similarity | Ranking | weight | Risk value | value |
| Corpus a | 50% | 3 | 1/6 = | 3 (a risk label is a | 0.51 |
| | | | 0.17 | label 1) | |
| Corpus b | 60% | 1 | 3/6 = | −1 (a risk label is | −0.5 |
| | | | 0.5 | risk-free label 2) | |
| Corpus c | 55% | 2 | 2/6 = | 2 (a risk label is a | 0.66 |
| | | | 0.33 | label 3) | |

Because the corpus database further includes the second corpus (namely, a risk-free corpus), the target corpus may also include a risk-free corpus. In other words, the target risk value of the target corpus can be a negative number. Therefore, the server can determine the sum of target risk values of the target object as the risk value of the target object, or the server can further determine the risk value of the target object based on an absolute value of the target risk value of the target corpus (for example, a target risk value with a largest absolute value can be determined as the risk value of the target object).

A method for determining the risk value of the target object is an optional and implementable determining method. In an actual application scenario, there can be a plurality of different determining methods. Different determining methods can be selected based on different actual application scenario. This is not specifically limited in this embodiment of this specification.

After determining the risk value of the target object, the server can determine, based on a preset risk threshold, whether the target object has a risk. For example, if the risk value of the target object is greater than the preset risk threshold, the server can determine that the target object has a risk.

If it is determined that the target object has a risk, the server can stop triggering a service related to the target object. For example, the target object can be user interaction content, in the resource transfer scenario, that is obtained by the terminal device. If it is determined that the interaction content has a risk, the server can stop triggering a corresponding resource transfer service.

In addition, if whether the target object has a risk is determined by performing matching processing on the target object by using only an argot as a keyword, a coverage effect is relatively good, and timeliness is relatively high, but an error recall rate is relatively high. In this application, when high timeliness is ensured, accuracy of risk identification of the target object can be improved by processing the target corpus. In a manner of identifying, by using a model, whether the target object has a risk, the argot updating speed is fast, a limited sample data amount can be obtained, there is a relatively high model iteration requirement, and there is relatively poor timeliness of a response to a risk. In this application, the corpus database can be constructed in the offline phase, to ensure a sample data amount requirement and a sample accuracy requirement of the corpus database. Processing such as sorting is performed on the target corpus, to improve a real-time identification effect, and model retraining and iteration do not need to be performed.

This embodiment of this specification provides the data processing method. The to-be-identified target object is obtained. If the target object includes a word matching the first argot, the target corpus corresponding to the target object is obtained from the corpus included in the pre-constructed corpus database. The pre-constructed corpus database includes the first corpus, the first corpus is the risk corpus constructed based on the second argot and the target risk corpus, and the target risk corpus includes the risk word that has the preset association relationship with the second argot. Whether the target object has a risk is determined based on the similarity between the target object and the target corpus and the risk label of the target corpus. In this way, whether the target object has a risk can be determined based on the target corpus that corresponds to the target object and that is obtained from the pre-constructed corpus database, to avoid low data processing efficiency caused by a manual determining manner. In addition, the first corpus in the pre-constructed corpus database is a risk corpus constructed based on the second argot and the target risk corpus, and the target risk corpus includes the risk word that has the preset association relationship with the second argot. Therefore, whether the target object has a risk can be accurately determined based on the determined similarity between the target corpus and the target object and the risk label of the target corpus. In other words, risk prevention and control efficiency and accuracy for the argot in the risk control scenario can be improved.

### Embodiment 3

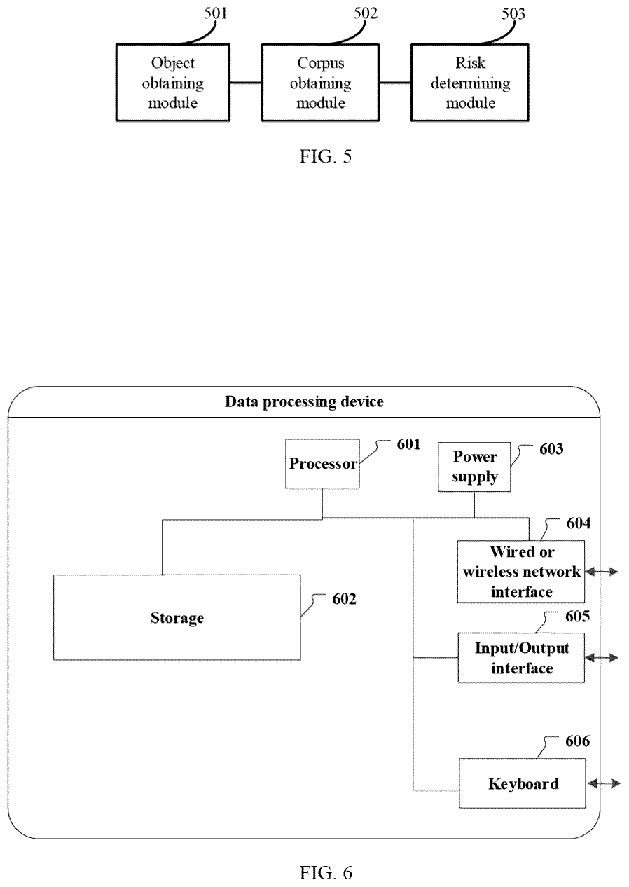

The data processing method provided in the embodiments of this specification is described above. Based on the same idea, this embodiment of this specification further provides a data processing apparatus, as shown in FIG. 5.

The data processing apparatus includes an object obtaining module 501, a corpus obtaining module 502, and a risk determining module 503. The object obtaining module 501 is configured to obtain a to-be-identified target object. The corpus obtaining module 502 is configured to: if the target object includes a word matching a first argot, obtain a target corpus corresponding to the target object from a corpus included in a pre-constructed corpus database. The pre-constructed corpus database includes a first corpus, the first corpus is a risk corpus constructed based on a second argot and a target risk corpus, and the target risk corpus includes a risk word that has a preset association relationship with the second argot. The risk determining module 503 is configured to determine, based on a similarity between the target object and the target corpus and a risk label of the target corpus, whether the target object has a risk.

In this embodiment of this specification, the apparatus further includes: a first obtaining module, configured to obtain the target risk corpus including the risk word that has the preset association relationship with the second argot; and a construction module, configured to: replace the risk word in the target risk corpus based on the second argot, to obtain the first corpus, and construct the corpus database based on the first corpus.

In this embodiment of this specification, the first obtaining module is configured to: obtain a first risk word that has the preset association relationship with the second argot; obtain a second risk word that is in a preset risk word knowledge map and that has the preset association relationship with the first risk word; and determine, as the target risk corpus, a risk corpus including the first risk word and a risk corpus including the second risk word.

In this embodiment of this specification, the pre-constructed corpus database further includes a second corpus, the second corpus is a risk-free corpus including the second argot, and the construction module is configured to: determine, as the second corpus, the risk-free corpus including the second argot, and construct the corpus database based on the first corpus and the second corpus.

In this embodiment of this specification, the construction module is configured to: perform feature extraction processing on the first corpus and the second corpus based on a pre-trained vector extraction model, to obtain a first representation vector corresponding to the first corpus and a second representation vector corresponding to the second corpus; and construct the corpus database based on the second argot, the first representation vector, a risk label of the first corpus, the second representation vector, and a risk label of the second corpus. The corpus obtaining module 502 is configured to: perform feature extraction processing on the target object based on the pre-trained vector extraction model, to obtain a target representation vector corresponding to the target object; and obtain the target corpus corresponding to the target object based on a similarity between the first argot and the second argot and/or a similarity between the target representation vector and a representation vector in the corpus database.

In this embodiment of this specification, there are a plurality of target corpora, and the risk determining module 503 is configured to: obtain similarities between the target representation vector of the target object and representation vectors of the target corpora, and sort the target corpora; and determine, based on a sorting sequence of the target corpora and the risk label of the target corpus, whether the target object has a risk.

In this embodiment of this specification, the risk determining module 503 is configured to: determine a risk value of the target object based on the sorting sequence of the target corpora and the risk label of the target corpus, and determine, based on the risk value of the target object, whether the target object has a risk.

In this embodiment of this specification, the risk determining module 503 is configured to: determine a risk weight of each target corpus based on the sorting sequence of the target corpora; determine a risk value of the target corpus based on the risk label of the target corpus; and determine the risk value of the target object based on the risk weight and the risk value of each target corpus.

This embodiment of this specification provides the data processing apparatus. The to-be-identified target object is obtained. If the target object includes a word matching the first argot, the target corpus corresponding to the target object is obtained from the corpus included in the pre-constructed corpus database. The pre-constructed corpus database includes the first corpus, the first corpus is the risk corpus constructed based on the second argot and the target risk corpus, and the target risk corpus includes the risk word that has the preset association relationship with the second argot. Whether the target object has a risk is determined based on the similarity between the target object and the target corpus and the risk label of the target corpus. In this way, whether the target object has a risk can be determined based on the target corpus that corresponds to the target object and that is obtained from the pre-constructed corpus database, to avoid low data processing efficiency caused by a manual determining manner. In addition, the first corpus in the pre-constructed corpus database is a risk corpus constructed based on the second argot and the target risk corpus, and the target risk corpus includes the risk word that has the preset association relationship with the second argot. Therefore, whether the target object has a risk can be accurately determined based on the determined similarity between the target corpus and the target object and the risk label of the target corpus. In other words, risk prevention and control efficiency and accuracy for the argot in the risk control scenario can be improved.

### Embodiment 4

Based on the same idea, an embodiment of this specification further provides a data processing device, as shown in FIG. 6.

The data processing device can vary greatly based on configuration or performance, and can include one or more processors 601 and a storage 602. The storage 602 can store one or more storage applications or data. The storage 602 can be a transitory storage or persistent storage. The application stored in the storage 602 can include one or more modules (not shown in the figure), and each module can include a series of computer-executable instructions in the data processing device. Still further, the processor 601 can be configured to communicate with the storage 602, to execute a series of computer-executable instructions in the storage 602 on the data processing device. The data processing device can further include one or more power supplies 603, one or more wired or wireless network interfaces 604, one or more input/output interfaces 605, and one or more keyboards 606.

Specifically, in this embodiment, the data processing device includes a storage and one or more programs. The one or more programs are stored in the storage. The one or more programs may include one or more modules, and each module may include a series of computer-executable instructions in the data processing device. One or more processors are configured to execute the following computer-executable instructions included in the one or more programs: obtaining a to-be-identified target object; if the target object includes a word matching a first argot, obtaining a target corpus corresponding to the target object from a corpus included in a pre-constructed corpus database, where the pre-constructed corpus database includes a first corpus, the first corpus is a risk corpus constructed based on a second argot and a target risk corpus, and the target risk corpus includes a risk word that has a preset association relationship with the second argot; and determining, based on a similarity between the target object and the target corpus and a risk label of the target corpus, whether the target object has a risk.

Optionally, before the obtaining a target corpus corresponding to the target object from a corpus included in a pre-constructed corpus database, the following operations are further included: obtaining the target risk corpus including the risk word that has the preset association relationship with the second argot; and replacing the risk word in the target risk corpus based on the second argot, to obtain the first corpus, and constructing the corpus database based on the first corpus.

Optionally, the obtaining the target risk corpus including the risk word that has the preset association relationship with the second argot includes: obtaining a first risk word that has the preset association relationship with the second argot; obtaining a second risk word that is in a preset risk word knowledge map and that has the preset association relationship with the first risk word; and determining, as the target risk corpus, a risk corpus including the first risk word and a risk corpus including the second risk word.

Optionally, the pre-constructed corpus database further includes a second corpus, the second corpus is a risk-free corpus including the second argot, and the constructing the corpus database based on the first corpus includes: determining, as the second corpus, the risk-free corpus including the second argot, and constructing the corpus database based on the first corpus and the second corpus.

Optionally, the constructing the corpus database based on the first corpus and the second corpus includes: performing feature extraction processing on the first corpus and the second corpus based on a pre-trained vector extraction model, to obtain a first representation vector corresponding to the first corpus and a second representation vector corresponding to the second corpus; and constructing the corpus database based on the second argot, the first representation vector, a risk label of the first corpus, the second representation vector, and a risk label of the second corpus; and the obtaining a target corpus corresponding to the target object from a corpus included in a pre-constructed corpus database includes: performing feature extraction processing on the target object based on the pre-trained vector extraction model, to obtain a target representation vector corresponding to the target object; and obtaining the target corpus corresponding to the target object based on a similarity between the first argot and the second argot and/or a similarity between the target representation vector and a representation vector in the corpus database.

Optionally, there are a plurality of target corpora, and the determining, based on a similarity between the target object and the target corpus and a risk label of the target corpus, whether the target object has a risk includes: obtaining similarities between the target representation vector of the target object and representation vectors of the target corpora, and sorting the target corpora; and determining, based on a sorting sequence of the target corpora and the risk label of the target corpus, whether the target object has a risk.

Optionally, the determining, based on a sorting sequence of the target corpora and the risk label of the target corpus, whether the target object has a risk includes: determining a risk value of the target object based on the sorting sequence of the target corpora and the risk label of the target corpus, and determining, based on the risk value of the target object, whether the target object has a risk.

Optionally, the determining a risk value of the target object based on the sorting sequence of the target corpora and the risk label of the target corpus includes: determining a risk weight of each target corpus based on the sorting sequence of the target corpora; determining a risk value of the target corpus based on the risk label of the target corpus; and determining the risk value of the target object based on the risk weight and the risk value of each target corpus.

This embodiment of this specification provides the data processing device. The to-be-identified target object is obtained. If the target object includes a word matching the first argot, the target corpus corresponding to the target object is obtained from the corpus included in the pre-constructed corpus database. The pre-constructed corpus database includes the first corpus, the first corpus is the risk corpus constructed based on the second argot and the target risk corpus, and the target risk corpus includes the risk word that has the preset association relationship with the second argot. Whether the target object has a risk is determined based on the similarity between the target object and the target corpus and the risk label of the target corpus. In this way, whether the target object has a risk can be determined based on the target corpus that corresponds to the target object and that is obtained from the pre-constructed corpus database, to avoid low data processing efficiency caused by a manual determining manner. In addition, the first corpus in the pre-constructed corpus database is a risk corpus constructed based on the second argot and the target risk corpus, and the target risk corpus includes the risk word that has the preset association relationship with the second argot. Therefore, whether the target object has a risk can be accurately determined based on the determined similarity between the target corpus and the target object and the risk label of the target corpus. In other words, risk prevention and control efficiency and accuracy for the argot in the risk control scenario can be improved.

### Embodiment 5

This embodiment of this specification further provides a computer-readable storage medium. A computer program is stored in the computer-readable storage medium. When the computer program is executed by a processor, each process of the embodiment of the data processing method is implemented, and the same technical effect can be achieved. To avoid repetition, details are omitted here for simplicity. The computer-readable storage medium is, for example, a read-only memory (ROM), a random access memory (RAM), a magnetic disk, or an optical disc.

This specification embodiment provides a computer-readable storage medium. The to-be-identified target object is obtained. If the target object includes a word matching the first argot, the target corpus corresponding to the target object is obtained from the corpus included in the pre-constructed corpus database. The pre-constructed corpus database includes the first corpus, the first corpus is the risk corpus constructed based on the second argot and the target risk corpus, and the target risk corpus includes the risk word that has the preset association relationship with the second argot. Whether the target object has a risk is determined based on the similarity between the target object and the target corpus and the risk label of the target corpus. In this way, whether the target object has a risk can be determined based on the target corpus that corresponds to the target object and that is obtained from the pre-constructed corpus database, to avoid low data processing efficiency caused by a manual determining manner. In addition, the first corpus in the pre-constructed corpus database is a risk corpus constructed based on the second argot and the target risk corpus, and the target risk corpus includes the risk word that has the preset association relationship with the second argot. Therefore, whether the target object has a risk can be accurately determined based on the determined similarity between the target corpus and the target object and the risk label of the target corpus. In other words, risk prevention and control efficiency and accuracy for the argot in the risk control scenario can be improved.

Some specific embodiments of this specification are described above. Other embodiments fall within the scope of the appended claims. In some cases, actions or steps described in the claims can be performed in a sequence different from that in the embodiments and desired results can still be achieved. In addition, the process depicted in the accompanying drawings does not necessarily need a particular sequence to achieve the desired results. In some implementations, multi-tasking and parallel processing are feasible or may be advantageous.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. Almost all designers program an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the programmable logic device is determined by a user through device programming. The designer independently performs programming to “integrate” a digital system to a PLD without requesting a chip manufacturer to design and manufacture an application-specific integrated circuit chip. In addition, at present, instead of manually manufacturing an integrated circuit chip, this type of programming is mostly implemented by using “logic compiler” software. The programming is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. It should also be clear to a person skilled in the art that a hardware circuit that implements a logical method procedure can be readily obtained once the method procedure is logically programmed by using the several hardware description languages described above and is programmed into an integrated circuit.

A controller can be implemented by using any proper method. For example, the controller can be a microprocessor or a processor, or a computer-readable medium that stores computer-readable program code (for example, software or firmware) that can be executed by the microprocessor or the processor, a logic gate, a switch, an application-specific integrated circuit (ASIC), a programmable logic controller, or an embedded microprocessor. Examples of the controller include but are not limited to the following microprocessors: ARC 625D, Atmel AT91SAM, Microchip PIC18F26K20, and Silicone Labs C8051F320. The storage controller can also be implemented as a part of control logic of the storage. A person skilled in the art also knows that in addition to implementing the controller by using only the computer-readable program code, logic programming can be performed on method steps to enable the controller to implement the same function in forms of the logic gate, the switch, the application-specific integrated circuit, the programmable logic controller, the built-in microcontroller, etc. Therefore, the controller can be considered as a hardware component, and an apparatus configured to implement various functions in the controller can also be considered as a structure in the hardware component. Alternatively, an apparatus configured to implement various functions can even be considered as both a software module implementing the method and a structure in the hardware component.

The systems, apparatuses, modules, or units described in the above-mentioned embodiments can be specifically implemented by a computer chip or an entity, or can be implemented by a product having a certain function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is described by dividing functions into various units. Certainly, during implementation of one or more embodiments of this specification, the functions of each unit can be implemented in one or more pieces of software and/or hardware.

A person skilled in the art should understand that the embodiments of this specification can be provided as methods, systems, or computer program products. Therefore, the one or more embodiments of this specification can use a form of hardware only embodiments, software only embodiments, or embodiments with a combination of software and hardware. In addition, the one or more embodiments of this specification can use a form of a computer program product that is implemented on one or more computer-usable storage media (including but not limited to a disk storage, a CD-ROM, an optical storage, etc.) that include computer-usable program code.

The embodiments of this specification are described with reference to the flowcharts and/or block diagrams of the method, the device (system), and the computer program product according to the embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more processes in the flowcharts and/or in one or more blocks in the block diagrams.

Alternatively, these computer program instructions can be stored in a computer-readable storage that can instruct a computer or another programmable data processing device to work in a specific manner, so the instructions stored in the computer-readable storage generate an artifact that includes an instruction apparatus. The instruction apparatus implements a specific function in one or more procedures in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPU), an input/output interface, a network interface, and a memory.

The memory may include a non-persistent memory, a random access memory (RAM), a nonvolatile memory, and/or another form in a computer-readable medium, for example, a read-only memory (ROM) or a flash memory (flash RAM). The memory is an example of the computer-readable medium.

The computer-readable medium includes persistent, non-persistent, movable, and unmovable media that can store information by using any method or technology. Information can be a computer-readable instruction, a data structure, a program module, or other data. Examples of the computer storage medium include but are not limited to a phase change random access memory (PRAM), a static random access memory (SRAM), a dynamic random access memory (DRAM), another type of RAM, a ROM, an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be configured to store information accessible by a computing device. Based on the definition in this specification, the computer-readable medium does not include transitory media such as a modulated data signal and carrier.

It is worthwhile to further note that the terms “include”, “comprise”, or any other variant thereof are intended to cover a non-exclusive inclusion, so that a process, a method, a product, or a device that includes a list of elements not only includes those elements but also includes other elements which are not expressly listed, or further includes elements inherent to such process, method, product, or device. Without more constraints, an element preceded by “includes a . . . ” does not preclude the existence of additional identical elements in the process, method, product, or device that includes the element.

A person skilled in the art should understand that the embodiments of this specification can be provided as methods, systems, or computer program products. Therefore, the one or more embodiments of this specification can use a form of hardware only embodiments, software only embodiments, or embodiments with a combination of software and hardware. In addition, the one or more embodiments of this specification can use a form of a computer program product that is implemented on one or more computer-usable storage media (including but not limited to a disk storage, a CD-ROM, an optical storage, etc.) that include computer-usable program code.

The one or more embodiments of this specification can be described in the general context of computer-executable instructions, for example, a program module. Usually, the program module includes a routine, a program, an object, a component, a data structure, etc. for executing a specific task or implementing a specific abstract data type. Alternatively, the one or more embodiments of this specification can be practiced in distributed computing environments. In the distributed computing environments, tasks are executed by remote processing devices connected by using a communication network. In the distributed computing environments, the program module can be located in a local and remote computer storage medium including a storage device.

The embodiments of this specification are described in a progressive way. For the same or similar parts of the embodiments, mutual references can be made to the embodiments. Each embodiment focuses on a difference from other embodiments. Particularly, the system embodiments are basically similar to the method embodiments, and therefore are described briefly. For related parts, references can be made to some descriptions in the method embodiments.

The above-mentioned descriptions are merely embodiments of this specification, and are not intended to limit this specification. A person skilled in the art can make various changes and variations to this specification. Any modification, equivalent replacement, or improvement made without departing from the spirit and principle of this specification shall fall within the scope of the claims in this specification.

1. A data processing method, comprising:
obtaining a to-be-identified target object;
upon determining that the target object comprises a word matching a first argot, obtaining a target corpus corresponding to the target object from a corpus comprised in a pre-constructed corpus database, wherein the pre-constructed corpus database comprises a first corpus, the first corpus is a risk corpus constructed based on a second argot and a target risk corpus, and the target risk corpus comprises a risk word that has a preset association relationship with the second argot; and
determining, based on a similarity between the target object and the target corpus and a risk label of the target corpus, whether the target object has a risk.

2. The method according to claim 1, wherein before obtaining a target corpus corresponding to the target object from a corpus comprised in a pre-constructed corpus database, the method further comprises:
obtaining the target risk corpus comprising the risk word that has the preset association relationship with the second argot; and
replacing the risk word in the target risk corpus based on the second argot, to obtain the first corpus, and constructing the corpus database based on the first corpus.

3. The method according to claim 2, wherein obtaining the target risk corpus comprising the risk word that has the preset association relationship with the second argot comprises:
obtaining a first risk word that has the preset association relationship with the second argot;
obtaining a second risk word that is in a preset risk word knowledge map and that has the preset association relationship with the first risk word; and
determining, as the target risk corpus, a risk corpus comprising the first risk word and a risk corpus comprising the second risk word.

4. The method according to claim 3, wherein the pre-constructed corpus database further comprises a second corpus, the second corpus is a risk-free corpus comprising the second argot, and constructing the corpus database based on the first corpus comprises:
determining, as the second corpus, the risk-free corpus comprising the second argot, and constructing the corpus database based on the first corpus and the second corpus.

5. The method according to claim 4, wherein constructing the corpus database based on the first corpus and the second corpus comprises:
performing feature extraction processing on the first corpus and the second corpus based on a pre-trained vector extraction model, to obtain a first representation vector corresponding to the first corpus and a second representation vector corresponding to the second corpus; and
constructing the corpus database based on the second argot, the first representation vector, a risk label of the first corpus, the second representation vector, and a risk label of the second corpus; and
the obtaining a target corpus corresponding to the target object from a corpus comprised in a pre-constructed corpus database comprises:
performing feature extraction processing on the target object based on the pre-trained vector extraction model, to obtain a target representation vector corresponding to the target object; and
obtaining the target corpus corresponding to the target object based on a similarity between the first argot and the second argot and/or a similarity between the target representation vector and a representation vector in the corpus database.

6. The method according to claim 5, wherein there are a plurality of target corpora, and determining, based on a similarity between the target object and the target corpus and a risk label of the target corpus, whether the target object has a risk comprises:
obtaining similarities between the target representation vector of the target object and representation vectors of the target corpora, and sorting the target corpora; and
determining, based on a sorting sequence of the target corpora and the risk label of the target corpus, whether the target object has a risk.

7. The method according to claim 6, wherein determining, based on a sorting sequence of the target corpora and the risk label of the target corpus, whether the target object has a risk comprises:
determining a risk value of the target object based on the sorting sequence of the target corpora and the risk label of the target corpus, and determining, based on the risk value of the target object, whether the target object has a risk.

8. The method according to claim 7, wherein determining a risk value of the target object based on the sorting sequence of the target corpora and the risk label of the target corpus comprises:
determining a risk weight of each target corpus based on the sorting sequence of the target corpora;
determining a risk value of the target corpus based on the risk label of the target corpus; and
determining the risk value of the target object based on the risk weight and the risk value of each target corpus.

9. (canceled)

10. A data processing device
comprising a memory and a processor, wherein the memory stores executable instructions that, in response to execution by the processor, cause the data processing device to:
obtain a to-be-identified target object;
upon determining that the target object comprises a word matching a first argot, obtain a target corpus corresponding to the target object from a corpus comprised in a pre-constructed corpus database, wherein the pre-constructed corpus database comprises a first corpus, the first corpus is a risk corpus constructed based on a second argot and a target risk corpus, and the target risk corpus comprises a risk word that has a preset association relationship with the second argot; and
determine, based on a similarity between the target object and the target corpus and a risk label of the target corpus, whether the target object has a risk.

11. A non-transitory computer-readable storage medium comprising instructions stored therein that, when executed by a processor of a computing device, cause the computing device to:
obtain a to-be-identified target object;
upon determining that the target object comprises a word matching a first argot, obtain a target corpus corresponding to the target object from a corpus comprised in a pre-constructed corpus database, wherein the pre-constructed corpus database comprises a first corpus, the first corpus is a risk corpus constructed based on a second argot and a target risk corpus, and the target risk corpus comprises a risk word that has a preset association relationship with the second argot; and
determine, based on a similarity between the target object and the target corpus and a risk label of the target corpus, whether the target object has a risk.

12. The data processing device according to claim 10, wherein the data processing device is further caused to:
obtain the target risk corpus comprising the risk word that has the preset association relationship with the second argot; and
replace the risk word in the target risk corpus based on the second argot, to obtain the first corpus, and construct the corpus database based on the first corpus.

13. The data processing device according to claim 12, wherein the data processing device being caused to obtain the target risk corpus comprising the risk word that has the preset association relationship with the second argot includes being caused to:
obtain a first risk word that has the preset association relationship with the second argot;
obtain a second risk word that is in a preset risk word knowledge map and that has the preset association relationship with the first risk word; and
determine, as the target risk corpus, a risk corpus comprising the first risk word and a risk corpus comprising the second risk word.

14. The data processing device according to claim 13, wherein the pre-constructed corpus database further comprises a second corpus, the second corpus is a risk-free corpus comprising the second argot, and the data processing device being caused to construct the corpus database based on the first corpus includes being caused to:
determine, as the second corpus, the risk-free corpus comprising the second argot, and construct the corpus database based on the first corpus and the second corpus.

15. The data processing device according to claim 14, wherein the data processing device being caused to construct the corpus database based on the first corpus and the second corpus includes being caused to:
perform feature extraction processing on the first corpus and the second corpus based on a pre-trained vector extraction model, to obtain a first representation vector corresponding to the first corpus and a second representation vector corresponding to the second corpus; and
construct the corpus database based on the second argot, the first representation vector, a risk label of the first corpus, the second representation vector, and a risk label of the second corpus; and
the data processing device being caused to obtain a target corpus corresponding to the target object from a corpus comprised in a pre-constructed corpus database includes being caused to:
perform feature extraction processing on the target object based on the pre-trained vector extraction model, to obtain a target representation vector corresponding to the target object; and
obtain the target corpus corresponding to the target object based on a similarity between the first argot and the second argot and/or a similarity between the target representation vector and a representation vector in the corpus database.

16. The data processing device according to claim 15, wherein there are a plurality of target corpora, and the data processing device being caused to determine, based on a similarity between the target object and the target corpus and a risk label of the target corpus, whether the target object has a risk includes being caused to:
obtain similarities between the target representation vector of the target object and representation vectors of the target corpora, and sort the target corpora; and
determine, based on a sorting sequence of the target corpora and the risk label of the target corpus, whether the target object has a risk.

17. The data processing device according to claim 16, wherein the data processing device being caused to determine, based on a sorting sequence of the target corpora and the risk label of the target corpus, whether the target object has a risk includes being caused to:
determine a risk value of the target object based on the sorting sequence of the target corpora and the risk label of the target corpus, and determine, based on the risk value of the target object, whether the target object has a risk.

18. The data processing device according to claim 17, wherein the data processing device being caused to determine a risk value of the target object based on the sorting sequence of the target corpora and the risk label of the target corpus includes being caused to:
determine a risk weight of each target corpus based on the sorting sequence of the target corpora;
determine a risk value of the target corpus based on the risk label of the target corpus; and
determine the risk value of the target object based on the risk weight and the risk value of each target corpus.

19. The non-transitory computer-readable storage medium according to claim 11, wherein the computing device is further caused to:
obtain the target risk corpus comprising the risk word that has the preset association relationship with the second argot; and
replace the risk word in the target risk corpus based on the second argot, to obtain the first corpus, and construct the corpus database based on the first corpus.

20. The non-transitory computer-readable storage medium according to claim 19, wherein the computing device being caused to obtain the target risk corpus comprising the risk word that has the preset association relationship with the second argot includes being caused to:
obtain a first risk word that has the preset association relationship with the second argot;
obtain a second risk word that is in a preset risk word knowledge map and that has the preset association relationship with the first risk word; and
determine, as the target risk corpus, a risk corpus comprising the first risk word and a risk corpus comprising the second risk word.

21. The non-transitory computer-readable storage medium according to claim 20, wherein the pre-constructed corpus database further comprises a second corpus, the second corpus is a risk-free corpus comprising the second argot, and the computing device being caused to construct the corpus database based on the first corpus includes being caused to:
determine, as the second corpus, the risk-free corpus comprising the second argot, and construct the corpus database based on the first corpus and the second corpus.
